(19) United States
(12) Patent Application Publication
(10) Pub. No.: US 2007/0120525 A1
(43) Pub. Date: May 31, 2007

(54) Electronic device with auxiliary unit that is usable detached from main unit of electronic device

(76) Inventor: Hiroyuki Tsuji, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/602,139

(22) Filed: Nov. 20, 2006

(30) Foreign Application Priority Data
Nov. 30, 2005 (JP) 2005-345910

(51) Int. Cl. H02J 7/00

(52) U.S. Cl. 320/110

(57) ABSTRACT

According to one embodiment, the first power supply circuit of a main unit includes a first recharging controller which sets a first battery at a first voltage, and is powered by a second voltage applied by an AC adaptor and higher than the first voltage, and first system power supply which is powered by the AC adaptor or first battery, and applies a third voltage lower than the first voltage. The second power supply circuit of an auxiliary unit includes a second recharging controller and second system power supply. The second recharging controller sets a second battery at a fourth voltage applied by the first system power supply and lower than the third voltage, and is powered by the third voltage when the auxiliary unit is attached to the main unit. The second system power supply is powered by the first system power supply or second battery.

### CROSS-REFERENCE TO RELATED APPLICATIONS

This application is based upon and claims the benefit of priority from Japanese Patent Application No. 2005-345910, filed Nov. 30, 2005, the entire contents of which are incorporated herein by reference.

### BACKGROUND

1. Field

One embodiment of the invention relates to an electronic device with an auxiliary unit that is usable detached from the main unit of the device.

2. Description of the Related Art

Various battery-driven portable personal computers, such as notebook personal computers, have been developed. Further, in recent years, so-called detachable personal computers, which incorporate an auxiliary unit detachable (separable) from the main unit and usable in a detached state, have been proposed (see, for example, Jpn. Pat. Appln. KOKAI Publication No. 11-212665). As well as detachable personal computers, other types of electronic devices, which incorporate an auxiliary unit detachable from the main unit and usable in a detached state, have been proposed (see, for example, Jpn. Pat. Appln. KOKAI Publication No. 11-327683).

In the conventional electronic devices as described in the above publications, a first rechargeable battery (first secondary battery) is mounted in the main unit. Further, a second rechargeable battery (second secondary battery) different from the first one is mounted in the auxiliary unit usable detached from the main unit. The second battery can be used independently of the first battery. The second battery enables the auxiliary unit to operate even if the unit is detached from the main unit of the electronic device.

The above publications do not describe the voltages of the first and second batteries. However, to operate the auxiliary unit regardless of whether the unit is attached to or detached from the main unit, the first and second batteries generally have the same cell structure for generating the same voltage. In this case, the electronic device main unit and auxiliary unit require first and second system power supplies and first and second recharging controllers for controlling the recharging of the first and second batteries, respectively.

When the auxiliary unit is used attached to the electronic device main unit, if a high-voltage power supply, such as an AC adaptor, is usable, the first and second system power supplies and the first and second recharging controllers are powered by a relatively high DC voltage generated by the high-voltage power supply. Accordingly, the first and second system power supplies must employ power supply ICs that can operate even if a high voltage is applied. Similarly, decoupling capacitors that can operate even if a high voltage is applied must be employed as the decoupling capacitors necessary for the first and second recharging controllers.

In the above electronic devices, it is difficult to reduce the size and width not only of the power supply circuit for the electronic device main unit, but also of the power supply circuit for the auxiliary unit that can be used detached from the main unit. Further, in the above electronic devices, the first and second batteries simultaneously discharge. Accordingly, when the auxiliary unit is used detached from the electronic device main unit, it is difficult to sufficiently use the capacity of the second battery mounted in the auxiliary unit.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate an embodiment of the invention and not to limit the scope of the invention.

FIG. 1 is a perspective view illustrating an exemplary detachable notebook personal computer 10 according to an embodiment of the invention;

FIG. 2 is a block diagram illustrating an exemplary system configuration of the main unit of the computer appearing in FIG. 1;

FIG. 3 is a block diagram illustrating an exemplary system configuration of the display unit appearing in FIG. 1; and

FIG. 4 is a block diagram mainly illustrating an exemplary configurations of the power supply circuits of the computer main unit and display unit.

### DETAILED DESCRIPTION

An embodiment according to the invention will be described hereinafter with reference to the accompanying drawings. In general, according to the embodiment, there is provided an electronic device. The electronic device comprises an electronic device main unit including a first system load, and an auxiliary unit permitted to be used attached to the electronic device main unit, and also permitted to be used detached from the electronic device main unit. The auxiliary unit includes a second system load. The electronic device main unit includes a first battery charged with a first voltage, and a first power supply circuit. The first power supply circuit includes a first recharging controller and first system power supply. The first recharging controller is configured to perform control for recharging the first battery to set the first battery at the first voltage. The first recharging controller is powered by a second voltage applied thereto by an AC adaptor. The second voltage is higher than the first voltage. The first system power supply is configured to apply a third voltage to the first system load. The third voltage is lower than the first voltage. The first system power supply is powered by the AC adaptor when the AC adaptor is used, and powered by the first battery when the AC adaptor is not used. The auxiliary unit includes a second battery set, by recharging, at a fourth voltage lower than the third voltage, and a second power supply circuit. The second power supply circuit includes a second recharging controller and second system power supply. The second recharging controller is configured to perform control for recharging the second battery to set the second battery at the fourth voltage. The second recharging controller is powered by the third voltage applied thereto by the first system power supply, when the auxiliary unit is attached to the electronic device main unit. The second system power supply is configured to apply a fifth voltage to the second system power supply. The second system power supply is powered by the first system power supply when the first system power supply is used, and powered by the second battery when the first system power supply is not used.

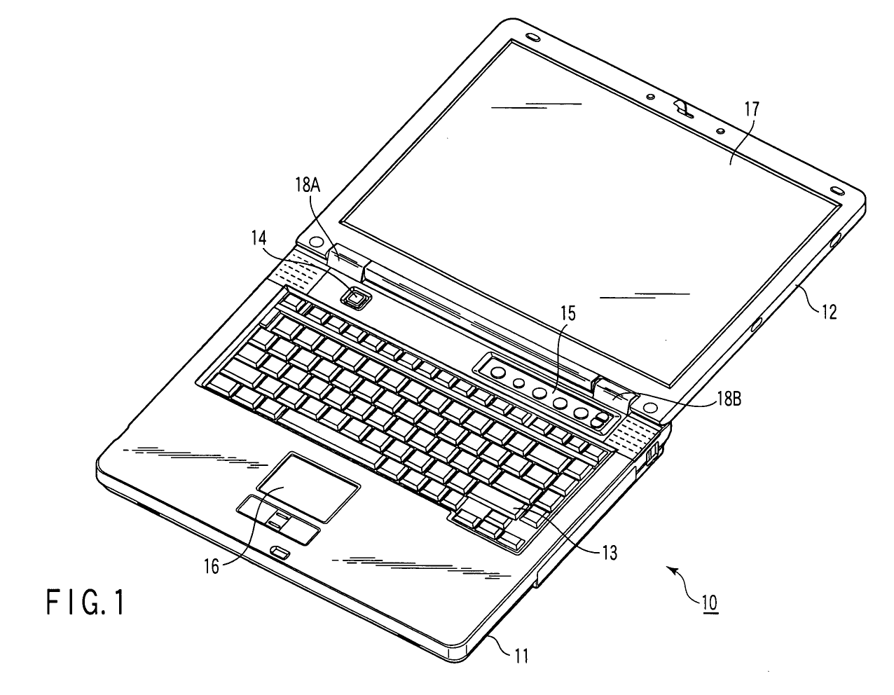

Referring first to FIGS. 1 to 4, the configuration of an electronic device according to the embodiment will be described. This electronic device is realized as a detachable notebook personal computer 10 powered by a battery.

FIG. 1 is a perspective view illustrating the state in which the display unit of the detachable personal computer 10 is open. The computer (electronic device) 10 comprises a computer main unit (electronic device main unit) 11 and display unit 12. The display unit 12 is an auxiliary unit as part of the computer 10, and can be operated independently of the computer main unit 11, detached therefrom.

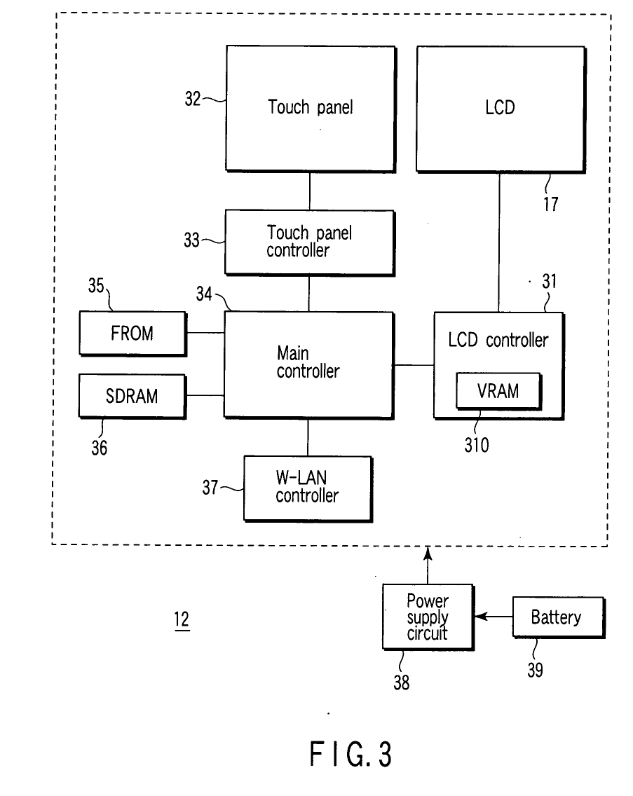

The display unit 12 incorporates a display device formed of a liquid crystal display (LCD) 17. The display screen of the LCD 17 is located at substantially the center of the display unit 12. A touch panel 32 (see FIG. 3) is provided on, for example, the front surface of the LCD 17.

The display unit 12 is attached to the computer main unit 11 by hinges 18A and 18B so that it can pivot between an open position and closed position. Like an input board incorporated in the thin computer disclosed in the previously described publication, i.e., Jpn. Pat. Appln. KOKAI Publication No. 11-212665, the display unit 12 is detachable from the computer main unit 11.

The computer main unit 11 has a case in a thin box shape, and incorporates, on its upper surface, a keyboard 13, power button switch 14, input operation panel 15 and touch pad 16. The power button switch 14 is used to power on and power off the computer 10. The input operation panel 15 includes a plurality of button switches for activating a plurality of functions, and serves as an input unit for inputting events corresponding to the button switches when they are pressed.

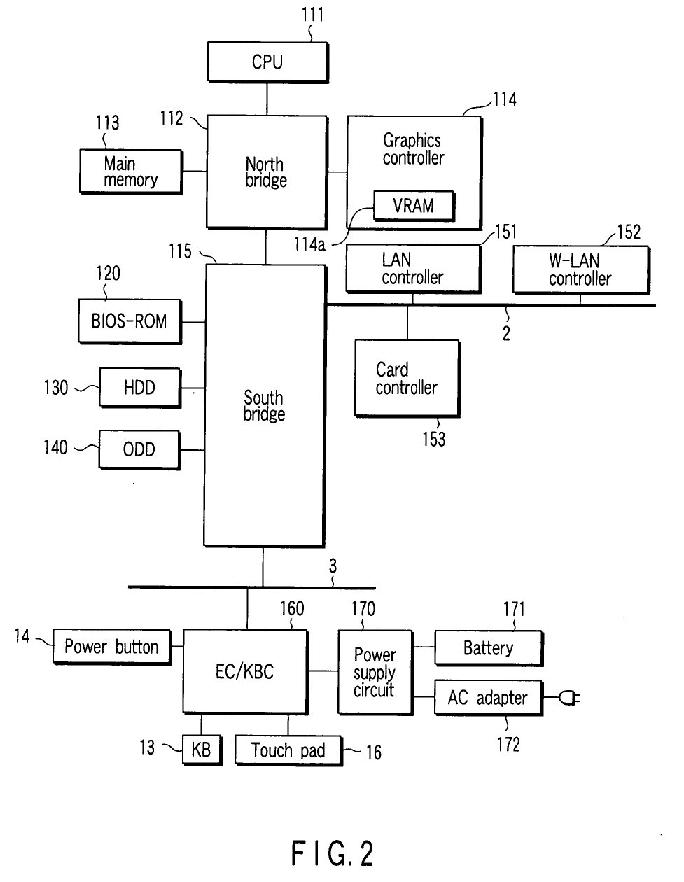

FIG. 2 is a block diagram illustrating the system configuration of the computer main unit 11. As shown, the computer main unit 11 comprises a CPU 111, north bridge 112, main memory 113, graphics controller 114 and south bridge 115. The computer main unit 11 further comprises a BIOS-ROM 120, hard disk drive (HDD) 130, optical disk drive (ODD) 140, LAN controller 151, wireless LAN controller (W-LAN controller) 152, card controller 153, embedded-controller/keyboard-controller IC (EC/KBC) 160 and power supply circuit 170.

The CPU 111 is a processor for controlling the entire operation of the computer 10. The CPU 111 executes an operating system (OS) loaded from the HDD 130 as a boot device to the main memory 113. The CPU 11 also executes various application programs. The CPU 11 further executes a basic input output system (BIOS) stored in the BIOS-ROM 120. The BIOS is a program for controlling the hardware.

The north bridge 112 is a bridge device connecting the local bus of the CPU 111 to the south bridge 115. The north bridge 112 contains a memory controller for controlling access to the main memory 113. Further, the north bridge 112 has a function for executing communication with the graphics controller 114 via an accelerated graphics port (AGP) bus.

The graphics controller 114 is a display controller for controlling the LCD 17 that is used as the display monitor of the computer 10. The graphics controller 114 is operable when the display unit 12 is used attached to the computer main unit 11. The graphics controller 114 includes a video memory (VRAM) 114a. Based on display data written to the VRAM 114a, the graphics controller 114 generates a video signal for forming a display image to be displayed on the LCD 17.

The south bridge 115 controls access to the BIOS-ROM 120. The BIOS-ROM 120 is a rewritable nonvolatile memory, such as a flash ROM. As described above, the BIOS-ROM 120 stores the BIOS. The south bridge 115 controls disk drives (I/O devices), such as the HDD 130 and ODD 140. The south bridge 115 is connected to a peripheral component interconnect (PCI) bus 2 and low pin count (LPC) bus 3, and controls the devices on the PCI bus 2 and LPC bus 3. The PCI bus 2 serves as a system bus.

The HDD 130 is a storage device for storing various types of software and data. The HDD 130 reads/writes data from/to a magnetic recording medium (magnetic disk), using a head (magnetic head). The HDD 130 prestores the OS. The OS is loaded to the main memory 113 in accordance with the BIOS stored in the BIOS-ROM 120, and is executed by the CPU 111.

The ODD 140 is a drive unit for driving (rotating) an optical record medium (optical disk), such as a compact disk (CD) or digital versatile disk (DVD), using a motor. The ODD 140 reads/writes data from/to an optical disk, using a head (optical head).

The PCI bus 2 is connected to the LAN controller 151, W-LAN controller 152 and card controller 153. The LAN controller 151 is a network controller for connecting the computer main unit 11 to a LAN (wired LAN). The W-LAN controller 152 is a network controller for connecting the computer main unit 11 to a wireless LAN. The card controller 153 controls a card device, such as a PC card or secure digital (SD) card, inserted in a card slot connected to the card controller 153.

The EC/KBC 160 is a microcomputer formed of a single chip that comprises an embedded controller for power supply management, and a keyboard controller for controlling the keyboard (KB) 13 and touch pad 16. The EC/KBC 160 cooperates with the power supply circuit 170 to realize a power supply control function for powering on and off the computer 10 in response to the operation of the power button switch 14 by a user. The power supply circuit 170 generates a system power supply voltage to be applied to each element of the computer main unit 11. For generating the system power supply voltage, the power supply circuit 170 uses a DC power supply voltage supplied from a rechargeable battery (first battery) 171 or an AC adaptor 172 serving as a high-voltage power supply. The AC adaptor 172 converts an AC power supply voltage into the DC power supply voltage.

FIG. 3 is a block diagram illustrating the system configuration of the display unit 12. As shown, the display unit 12 comprises, as well as the LCD 17 shown in FIG. 1, an LCD controller 31, touch panel 32, touch panel controller 33, main controller 34, flash ROM (FROM) 35, synchronous DRAM (SDRAM) 36, W-LAN controller 37, power supply circuit 38 and battery 39.

The LCD controller 31 is a display controller for controlling the LCD 17. The LCD controller 31 is operable when the display unit 12 is used detached from the computer main unit 11. The LCD controller 31 includes a video memory (VRAM) 310. Based on display data written to the VRAM 310, the LCD controller 31 generates a video signal for forming a display image to be displayed on the LCD 17.

The touch panel 32 is an input surface for enabling a user to designate a position thereon when they touch it by their finger. The touch panel 32 is transparent and is located at, for example, the front surface of the LCD 17. The touch panel controller 33 detects the position on the touch panel 32 touched by the finger. As a result, the user can directly designate, by their finger, various menus, for example, displayed on the LCD 17 by the LCD controller 31. Instead of the touch panel 32 and touch panel controller 33, a tablet (digitizer) capable of designating a position using, for example, a pen, and a tablet controller (digitizer controller) may be employed.

The main controller 34 controls the entire operation of the display unit 12. The main controller 34 comprises, for example, a CPU and I/O controller, which are not shown. The CPU executes various programs stored in the FROM 35. The I/O controller controls data input/output between the LCD controller 31, touch panel controller 33 and W-LAN controller 37. Part of the SDRAM 36 is used as a work area for the CPU of the main controller 34. In the embodiment, the programs stored in the FROM 35 include a program for an Internet viewer, i.e., a so-called browser.

The W-LAN controller 37 is a network controller for connecting the display unit 12 to a wireless LAN. By virtue of the W-LAN controller 37, the main controller 34 enables the display unit 12 to function as an independent Internet viewer, in accordance with the program for the Internet viewer. Further, the main controller 34 enables the display unit 12 to function as part of the computer 10, by causing the W-LAN controller 37 to perform wireless communication with the W-LAN controller 152 of the computer main unit 11.

Instead of wireless communication by the W-LAN controllers 37 and 152, other wireless communication devices, such as super-wideband wireless controllers, can be used. Further, if the computer main unit 11 is electrically connected to the display unit 12 by a connector, communication can be performed between the computer main unit 11 and display unit 12 via, for example, the PCI bus 2 or LAN line.

The power supply circuit 38 generates a power supply voltage (system power supply voltage) for powering the elements in the display unit 12. When the display unit 12 is attached to the computer main unit 11, the power supply circuit 38 is powered by the system power supply voltage generated by the power supply circuit 170 of the computer main unit 11. In contrast, when the display unit 12 is detached from the computer main unit 11, the power supply circuit 38 is powered by the voltage generated by the battery 39. The battery 39 is a rechargeable one, and generates a lower voltage than the battery 171 of the computer main unit 11. In the embodiment, the battery 39 generates a voltage of +4V, and the battery 171 generates a voltage of +12V.

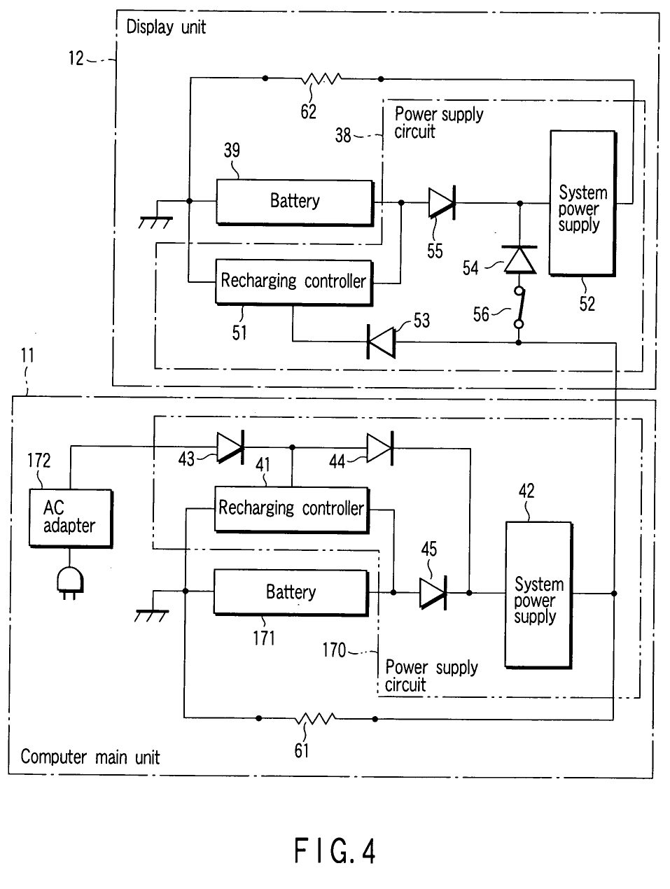

FIG. 4 is a block diagram mainly illustrating the power supply circuits 170 and 38 incorporated in the computer main unit 11 and display unit 12, respectively. The power supply circuit (first power supply circuit) 170 of the computer main unit 11 comprises a recharging controller (first recharging controller) 41, system power supply (first system power supply) 42 and diodes 43, 44 and 45. The output (the output-side positive terminal) of the AC adaptor 172 is connected to the anode of the diode (first diode) 43, and the cathode of the diode 43 is connected to the input of the recharging controller 41. The AC adaptor 172 is formed of, for example, an AC-to-DC converter for converting the commercial AC voltage into a DC voltage of +15V.

Accordingly, when the AC power supply is connected to the computer main unit 11 via the AC adaptor 172, the DC voltage of +15V output from the AC adaptor 172 is applied to the input of the recharging controller 41 via the diode 43. When the DC voltage (second voltage) is applied to the recharging controller 41, the recharging controller 41 performs control for recharging the battery 171 with, for example, +12V (first voltage).

The cathode of the diode 43 is connected to the anode of the diode 44 (second diode), as well as to the input of the recharging controller 41. The positive terminal of the battery 171 is connected to the anode of the diode 45 (third diode), and the cathode of the diode 45 is connected to the cathode of the diode 44 and the input of the system power supply 42.

This enables both the AC adaptor 172 and battery 171 to apply their DC voltages to the input of the system power supply 42. Since the voltage (+15V) applied by the AC adaptor 172 is higher than the voltage (+12V) applied by the battery 171, the system power supply 42 is powered by the voltage (+15V) applied by the AC adaptor 172. At this time, the discharge of the battery 171 is suppressed.

In contrast, when the computer main unit 11 is not connected to the AC power supply, for instance, when the user carries the computer 10, the system power supply 42 is powered by the battery 171. The system power supply 42 is formed of a DC-to-DC converter. The system power supply 42 converts the applied voltage +12V into, for example, +5V. The voltage of +5V is used as a power supply voltage for a load (system load) 61 that includes the elements of the computer main unit 11.

The diode 43 is a backflow preventing device, and prevents backflow of the current acquired when the DC voltage is applied by the AC adaptor 172, with the polarity (+) or (−) of the voltage reversed. The diode 44 prevents backflow of a current to the recharging controller 41. The diode 45 prevents the DC voltage from being directly applied to the battery 171 by the AD adaptor 172.

On the other hand, the power supply circuit (second power supply circuit) 38 of the display unit 12 comprises a recharging controller (second recharging controller) 51, system power supply (second system power supply) 52, diodes 53, 54 and 55, and switch 56. When the display unit 12 is attached to the computer main unit 11, the output (output-side positive terminal) of the system power supply 42 of the computer main unit 11 is connected to the anode of the diode 53 (fourth diode) via, for example, a power supply connector (not shown). The cathode of the diode 53 is connected to the input of the recharging controller 51. In this structure, the system power supply 42 of the computer main unit 11 applies the DC voltage of +5V to the recharging controller 51 via the diode 53. The recharging controller 51, in turn, performs control for recharging the battery 39 with, for example, +4V.

Since the voltage (+5V) applied to the recharging controller 51 is lower than the voltage (+12V) applied to the recharging controller 41 of the computer main unit 11, the decoupling capacitor necessary for the recharging controller 51 can be set to a lower withstand voltage than that necessary for the recharging controller 41. Similarly, the power supply IC necessary for the system power supply 52 can be set to a lower withstand voltage than that necessary for the system power supply 42 of the computer main unit 11. As a result, the power supply circuit 38 including the recharging controller 51 and system power supply 52 can be made compact and thin, and accordingly, the display unit 12 can be made more compact and thinner and hence be carried more easily.

The positive terminal of the battery 39 is connected to the anode of the diode 55 (fifth diode), and the cathode of the diode 55 is connected to the cathode of the diode 54 (fifth diode) and the input of the system power supply 54. The anode of the diode 53 is connected to the anode of the diode 54 via the switch 56.

By virtue of this structure, when the display unit 12 is attached to the computer main unit 11 and the switch 56 is closed, both the system power supply 42 of the computer main unit 11 and the battery 39 can apply their DC voltages to the input of the system power supply 52. Since the voltage (+5V) applied by the system power supply 42 is higher than the voltage (+4V) applied by the battery 39, the system power supply 52 is powered by the system power supply 42. Namely, the switch 56 in the closed state is used as a selection switch that enables the system power supply 52 to be powered by the system power supply 42.

When the system power supply 52 is powered by the system power supply 42, the discharge of the battery 39 is suppressed. However, at this time, the voltage applied to the system power supply 52 is regulated to the lower one of the voltages applied by the system power supply 42 and battery 39, i.e., the voltage (+4V) of the battery 39. Namely, the system power supply 52 is powered by the voltage of +4V.

In contrast, when the display unit 12 is used singly, detached from the computer main unit 11, the system power supply 52 is powered by the battery 39. As described above, when the display unit 12 is attached to the computer main unit 11, the system power supply 52 is powered by the system power supply 42 of the computer main unit 11. In this state, the battery 39 of the display unit 12 does not discharge, i.e., the charge accumulated therein is not consumed. Therefore, when the display unit 12 is singly used detached from the computer main unit 11, the capacity of the battery 39 can be sufficiently utilized, thereby enabling the display unit to be powered for a long time by the battery 39.

The system power supply 52 is formed of a DC-to-DC converter. The system power supply 52 converts the applied voltage +4V into, for example, +3.3V. The voltage of +3.3V is used as a power supply voltage for a load (system load) 62 that includes the elements of the display unit 12. It is a matter of course that if a power supply voltage for each element in the display unit 12 exceeds +4V, e.g., if it is +5V that is equal to the power supply voltage for each element in the computer main unit 11, the applied voltage of +4V is boosted to +5V.

The diode 53 is a backflow preventing device, and prevents backflow of the current acquired when the DC voltage applied by the system power supply 42 has the reverse polarity. Further, the diode 54 prevents the voltage from being applied by the battery 39 to the system power supply 42. The diode 55 prevents the DC voltage from being directly applied to the battery 39 by the system power supply 42.

The anodes of the diodes 53 and 54 are connected to each other via the switch 56. When the switch 56 is closed and the display unit 12 is attached to the computer main unit 11, the system power supply 52 of the display unit 12 is powered by the system power supply 42 of the computer main unit 11, as described above. Assume here that since, for example, the user carries the computer 10, the computer main unit 11 is not connected to the AC power supply. In this case, the system power supply 42 of the computer main unit 11 is powered by the battery 171. This means that the system power supply 52 of the display unit 12 is powered by the battery 171. Namely, when the switch 56 is closed in a particular state in which the display unit 12 is attached to the computer main unit 11, and the computer main unit 11 is disconnected from the AC power supply, the display unit 12 is powered by the battery 171 of the computer main unit 11.

Assume here that the switch 56 is opened in the particular state. At this time, the battery 39 of the display unit 12 starts to discharge to power the system power supply 52 of the display unit 12. Namely, the switch 56 in the open state is used as a selection switch that prevents the system power supply 52 from being powered by the system power supply 42.

As described above, in the embodiment, when the switch 56 is closed in the above-described particular state, the display unit 12 can be powered by the battery 171 of the computer main unit 11. Further, when the switch 56 is open in the above-described particular state, the display unit 12 can be powered by the battery 39 thereof. This being so, the display unit 12 can be operated for a longer time in the particular state.

While a certain embodiment of the invention has been described, it has been presented by way of example only, and is not intended to limit the scope of the invention. Indeed, the novel apparatus and method described herein may be embodied in a variety of other forms; furthermore, various omissions, substitutions and changes in the form of the apparatus and method described herein may be made without departing from the spirit of the invention. The accompanying claims and their equivalents are intended to cover such forms or modification as would fall within the scope and spirit of the invention.

What is claimed is:

1. An electronic device comprising:
an electronic device main unit including a first system load; and
an auxiliary unit permitted to be used attached to the electronic device main unit, and also permitted to be used detached from the electronic device main unit, the auxiliary unit including a second system load,
wherein:
the electronic device main unit includes:
a first battery charged with a first voltage; and
a first power supply circuit, the first power supply circuit including:
a first recharging controller configured to perform control for recharging the first battery to set the first battery at the first voltage, the first recharging controller being powered by a second voltage applied thereto by an AC adaptor, the second voltage being higher than the first voltage; and
a first system power supply configured to apply a third voltage to the first system load, the third voltage being lower than the first voltage, the first system power supply being powered by the AC adaptor when the AC adaptor is used, and powered by the first battery when the AC adaptor is not used,
the auxiliary unit includes:
a second battery set, by recharging, at a fourth voltage lower than the third voltage; and
a second power supply circuit, the second power supply circuit including:
a second recharging controller configured to perform control for recharging the second battery to set the second battery at the fourth voltage, the second recharging controller being powered by the third voltage applied thereto by the first system power supply, when the auxiliary unit is attached to the electronic device main unit; and
a second system power supply configured to apply a fifth voltage to the second system power supply, the second system power supply being powered by the first system power supply when the first system power supply is used, and powered by the second battery when the first system power supply is not used.

2. The electronic device according to claim 1, wherein the second power supply circuit further includes a switch used to select whether the first system power supply is used to power the second system power supply when the auxiliary unit is attached to the electronic device main unit.

3. The electronic device according to claim 1, wherein the first power supply circuit further includes:
a first diode interposed between an input of the first recharging controller and an output of the AC adaptor;
a second diode interposed between the input of the first recharging controller and an input of the first system power supply; and
a third diode interposed between the first battery and the input of the first system power supply.

4. The electronic device according to claim 3, wherein the second power supply circuit further includes:
a fourth diode interposed between an input of the second recharging controller and an output of the first system power supply;
a fifth diode interposed between the second battery and an input of the second system power supply; and
a sixth diode interposed between an anode of the fourth diode and a cathode of the fifth diode.

5. The electronic device according to claim 4, wherein the second power supply circuit further includes a switch interposed between the anode of the fourth diode and an anode of the sixth diode.
